(19) United States
(12) Patent Application Publication
(10) Pub. No.: US 2026/0043948 A1
(43) Pub. Date: Feb. 12, 2026

(54) HARD COATING COMPOSITION, WINDOW, AND ELECTRONIC DEVICE INCLUDING THE WINDOW

(71) Applicant: Samsung Display Co., LTD., Yongin-si (KR)

(72) Inventor: JONGHWAN CHO, Yongin-si (KR)

(73) Assignee: Samsung Display Co., LTD., Yongin-si (KR)

(21) Appl. No.: 19/192,818

(22) Filed: Apr. 29, 2025

(30) Foreign Application Priority Data
Aug. 9, 2024 (KR) 10-2024-0106788

(51) Int. Cl. G02B 1/14; C08F 283/12; C08K 3/36; C09D 4/00; C09D 5/00; C09D 7/20; C09D 7/40; C09D 7/61; C09D 151/08; G02B 1/11

(52) U.S. Cl. CPC G02B 1/14; C08F 283/124; C09D 4/00; C09D 5/006; C09D 7/20; C09D 7/61; C09D 7/67; C09D 151/085; C08K 3/36; C08K 2201/011; G02B 1/11

(57) ABSTRACT

Embodiments provide a hard coating composition, a window produced from the hard coating composition, a method of manufacturing the window, and an electronic device including the window. The hard coating composition includes a solvent and a hard coating solid matter, wherein the hard coating solid matter includes a silsesquioxane compound, and a photo-polymerization initiator. The silsesquioxane compound is represented by Formula 1, which is explained in the specification.

### CROSS-REFERENCE TO RELATED APPLICATION(S)

This application claims priority to and benefits of Korean Patent Application No. 10-2024-0106788 under 35 U.S.C. § 119, filed on Aug. 9, 2024, in the Korean Intellectual Property Office, the entire contents of which are incorporated herein by reference.

### BACKGROUND

### 1. Technical Field

Embodiments relate to a hard coating composition for forming a hard coating layer, and a window for a foldable electronic device including the hard coating layer.

### 2. Description of the Related Art

Various types of display devices are used to provide images and information. A display device may include a display panel for displaying an image, and a window for protecting the display panel. A user sees an image that is displayed on the display panel through the window.

The window may include various layers to improve durability and prevent fingerprints. For example, the window may include a base layer, and a hard coating layer disposed on the base layer. The hard coating layer may improve durability, such as by increasing the hardness of the base layer.

It is to be understood that this background of the technology section is, in part, intended to provide useful background for understanding the technology. However, this background of the technology section may also include ideas, concepts, or recognitions that were not part of what was known or appreciated by those skilled in the pertinent art prior to a corresponding effective filing date of the subject matter disclosed herein.

### SUMMARY

Embodiments provide a hard coating composition for forming a hard coating layer.

Embodiments also provide a window including the hard coating layer formed using the hard coating composition and having improved flexibility and durability.

Embodiments also provide a method for manufacturing the window.

Embodiments also provide an electronic device including the window.

Additional features will be set forth in the description which follows, and in part will be apparent from the description, or may be learned by practice of the embodiments of the disclosure.

According to embodiments, a hard coating composition may include a solvent, and a hard coating solid matter. The hard coating solid matter may include a silsesquioxane compound represented by Formula 1, and a photo-polymerization initiator. In Formula 1, R₁ may represent pentaerythritol tetraacrylate, and R₂ may represent trimethylolpropane trimethacrylate:

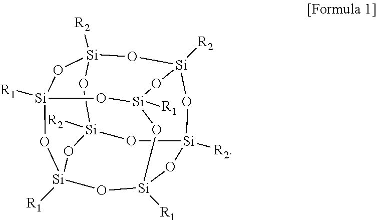

In an embodiment, the hard coating solid matter may further include silica nanoparticles.

In an embodiment, with respect to 100 wt % of the hard coating solid matter, the hard coating solid matter may include about 85 wt % to about 95 wt % of the silsesquioxane compound, about 1 wt % to about 5 wt % of the photo-polymerization initiator, and about 2 wt % to about 10 wt % of the silica nanoparticles.

In an embodiment, an average diameter of the silica nanoparticles may be in a range of about 20 nanometers (nm) to about 60 nm.

In an embodiment, the photo-polymerization initiator may be diphenyl(2,4,6-trimethylbenzoyl) phosphine oxide.

In an embodiment, the solvent may include at least one of 2-butanone and 1-methoxy-2-methyl-2-propanol.

According to embodiments, a window may include a base layer, and a hard coating layer on the base layer. The hard coating layer may include a silsesquioxane compound represented by Formula 1, and a photo-polymerization initiator. In Formula 1, R₁ may represent pentaerythritol tetraacrylate, and R₂ may represent trimethylolpropane trimethacrylate.

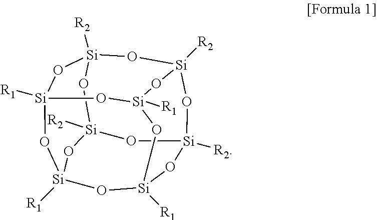

In an embodiment, the hard coating layer may further include silica nanoparticles.

In an embodiment, an average diameter of the silica nanoparticles may be in a range of about 20 nm to about 60 nm.

In an embodiment, the photo-polymerization initiator may be diphenyl(2,4,6-trimethylbenzoyl) phosphine oxide.

In an embodiment, a thickness of the hard coating layer may be in a range of about 3 (μm) to about 5 μm.

In an embodiment, the window may further include an anti-reflection layer on the hard coating layer. The anti-reflection layer may include high refractive index layers and low refractive index layers, alternately stacked on each other.

According to embodiments, a method for manufacturing a window may include: applying a hard coating composition including a solvent and a hard coating solid matter on a base layer to form a preliminary hard coating layer; drying the preliminary hard coating layer to remove the solvent; and photo-curing the dried preliminary hard coating layer to form a hard coating layer. The hard coating solid matter may include a silsesquioxane compound represented by Formula 1, and a photo-polymerization initiator. In Formula 1, R₁ may represent pentaerythritol tetraacrylate, and R₂ may represent trimethylolpropane trimethacrylate.

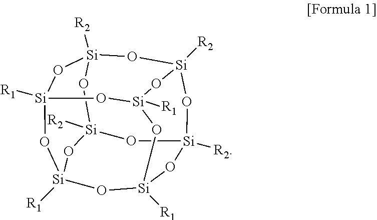

In an embodiment, the hard coating composition may be applied by wet coating.

In an embodiment, the hard coating solid matter may further include silica nanoparticles.

In an embodiment, with respect to 100 wt % of the hard coating solid matter, the hard coating composition may include about 85 wt % to about 95 wt % of the silsesquioxane compound, about 1 wt % to about 5 wt % of the photo-polymerization initiator, and about 2 wt % to about 10 wt % of the silica nanoparticles.

In an embodiment, the photo-polymerization initiator may be diphenyl(2,4,6-trimethylbenzoyl) phosphine oxide.

In an embodiment, the solvent may include at least one of 2-butanone and 1-methoxy-2-methyl-2-propanol.

In an embodiment, the method may further include forming an anti-reflection layer by alternately stacking high refractive index layers and low refractive index layers on the hard coating layer.

In an embodiment, the high refractive index layers and the low refractive index layers may each be formed by vacuum deposition.

According to embodiments, an electronic device may include a display panel including pixels, and a window on the display panel, wherein the window may include a base layer, and a hard coating layer on the base layer. The hard coating layer may include a silsesquioxane compound represented by Formula 1, and a photo-polymerization initiator. In Formula 1, R₁ may represent pentaerythritol tetraacrylate, and R₂ may represent trimethylolpropane trimethacrylate.

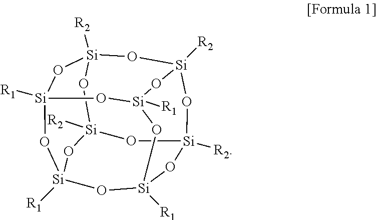

According to embodiments, the hard coating layer of the window may have excellent flexibility while also improving hardness and wear resistance. Accordingly, the window may be suitable for use in a foldable electronic device.

It is to be understood that the embodiments above are described in a generic and explanatory sense only and not for the purposes of limitation, and the disclosure is not limited to the embodiments described above.

### BRIEF DESCRIPTION OF THE DRAWINGS

The accompanying drawings are included to provide a further understanding of the embodiments, and are incorporated in and constitute a part of this specification. The drawings illustrate embodiments of the disclosure and principles thereof. The above and other aspects and features of the disclosure will become more apparent by describing in detail embodiments thereof with reference to the accompanying drawings, in which:

FIGS. 1 to 3 are each a schematic perspective view of an electronic device according to an embodiment.

FIG. 4 is a schematic cross-sectional view of an electronic device according to an embodiment, taken along virtual line I-I′ in FIG. 1.

FIG. 5 is a schematic cross-sectional view of a display panel included in the electronic device of FIG. 4.

FIG. 6 is a schematic cross-sectional view of a window included in the electronic device of FIG. 4.

### DETAILED DESCRIPTION OF THE EMBODIMENTS

The disclosure will now be described more fully hereinafter with reference to the accompanying drawings, in which embodiments are shown. This disclosure may, however, be embodied in different forms and should not be construed as limited to the embodiments set forth herein. Rather, these embodiments are provided so that this disclosure will be thorough and complete, and will fully convey the scope of the disclosure to those skilled in the art.

In the drawings, the sizes, thicknesses, ratios, and dimensions of the elements may be exaggerated for ease of description and for clarity. Like reference numbers and reference characters refer to like elements throughout.

In the specification, it will be understood that when an element (or region, layer, part, etc.) is referred to as being “on”, “connected to”, or “coupled to” another element, it can be directly on, connected to, or coupled to the other element, or one or more intervening elements may be present therebetween. In a similar sense, when an element (or region, layer, part, etc.) is described as “covering” another element, it can directly cover the other element, or one or more intervening elements may be present therebetween.

In the specification, when an element is “directly on,” “directly connected to,” or “directly coupled to” another element, there are no intervening elements present. For example, “directly on” may mean that two layers or two elements are disposed without an additional element such as an adhesion element therebetween.

As used herein, the expressions used in the singular such as “a,” “an,” and “the,” are intended to include the plural forms as well, unless the context clearly indicates otherwise.

As used herein, the term “and/or” includes any and all combinations of one or more of the associated listed items. For example, “A and/or B” may be understood to mean “A, B, or A and B.” The terms “and” and “or” may be used in the conjunctive or disjunctive sense and may be understood to be equivalent to “and/or”.

In the specification and the claims, the term “at least one of” is intended to include the meaning of “at least one selected from the group consisting of” for the purpose of its meaning and interpretation. For example, “at least one of A, B, and C” may be understood to mean A only, B only, C only, or any combination of two or more of A, B, and C, such as ABC, ACC, BC, or CC. When preceding a list of elements, the term, “at least one of,” modifies the entire list of elements and does not modify the individual elements of the list.

It will be understood that, although the terms first, second, etc. may be used herein to describe various elements, these elements should not be limited by these terms. These terms are only used to distinguish one element from another element. Thus, a first element could be termed a second element without departing from the teachings of the disclosure. Similarly, a second element could be termed a first element, without departing from the scope of the disclosure.

The spatially relative terms “below”, “beneath”, “lower”, “above”, “upper”, or the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in other directions and thus the spatially relative terms may be interpreted differently depending on the orientations.

The terms “about” or “approximately” as used herein is inclusive of the stated value and means within an acceptable range of deviation for the recited value as determined by one of ordinary skill in the art, considering the measurement in question and the error associated with measurement of the recited quantity (i.e., the limitations of the measurement system). For example, “about” may mean within one or more standard deviations, or within ±20%, ±10%, or ±5% of the stated value.

It should be understood that the terms “comprises,” “comprising,” “includes,” “including,” “have,” “having,” “contains,” “containing,” and the like are intended to specify the presence of stated features, integers, steps, operations, elements, components, or combinations thereof in the disclosure, but do not preclude the presence or addition of one or more other features, integers, steps, operations, elements, components, or combinations thereof.

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

Hereinafter, embodiments will be described in detail with reference to the accompanying drawings.

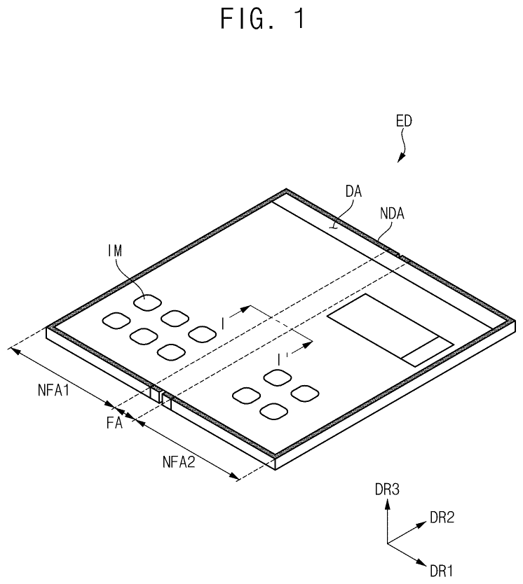

FIGS. 1 to 3 are each a schematic perspective view of an electronic device according to an embodiment.

Referring to FIGS. 1 to 3, an electronic device ED may be a device that is activated according to an electrical signal. For example, the electronic device ED may be a small electronic device, such as a smart phone, a mobile phone, a smart watch, a game console, a camera, or the like, but embodiments are not limited thereto. FIGS. 1 to 3 illustrate a foldable smart phone as an embodiment of the small electronic device.

As illustrated in FIG. 1, the electronic device ED may include a display surface for displaying an image IM. For example, the display surface may be substantially parallel to a plane defined by a first direction DR1 and a second direction DR2 crossing the first direction DR1. The second direction DR2 may be perpendicular to the first direction DR1. The electronic device ED may display the image IM in a third direction DR3 substantially parallel to a normal direction of the display surface. The third direction DR3 may be perpendicular to each of the first direction DR1 and the second direction DR2. Hereinafter, the third direction DR3 may be referred to as a thickness direction.

The electronic device ED may include a display area DA and a peripheral area NDA. The display area DA may display the image IM by generating light or by controlling a transmittance of light provided from an external light source. The peripheral area NDA may be adjacent to the display area DA. For example, the peripheral area NDA may surround at least a portion of the display area DA in a plan view. In an embodiment, the peripheral area NDA may not display an image. However, embodiments are not limited thereto, and an image may be displayed in at least a portion of the peripheral area NDA.

The electronic device ED may be a foldable electronic device that can be folded and unfolded. The electronic device ED may include a folding area FA and non-folding areas NFA1 and NFA2. In an embodiment, as illustrated in FIG. 1, the electronic device ED may include a first non-folding area NFA1 and a second non-folding area NFA2 spaced apart from each other, and the folding area FA may be disposed between the first non-folding area NFA1 and the second non-folding area NFA2. Although FIG. 1 illustrates that the electronic device ED includes one folding area and two non-folding areas, embodiments are not limited thereto, and the electronic device ED may include two or more folding areas and three or more non-folding areas.

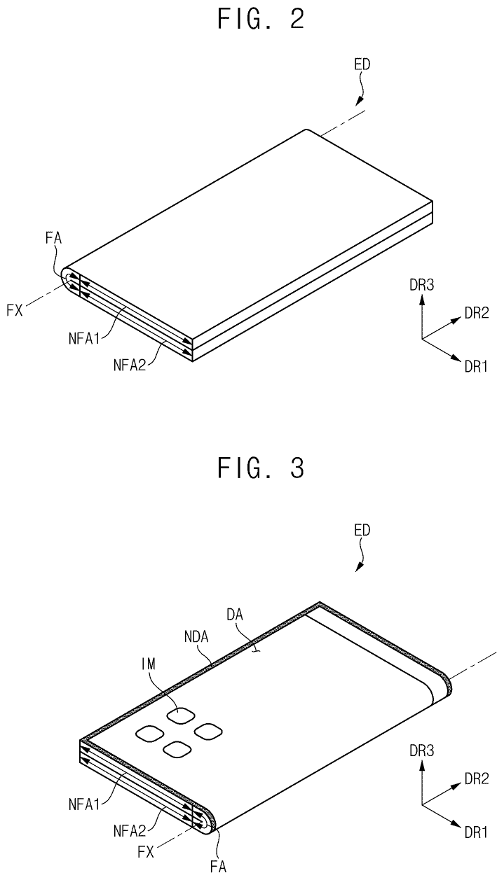

In an embodiment, the folding area FA may extend in the second direction DR2. The second non-folding area NFA2 may be spaced apart from the first non-folding area NFA1 in the first direction DR1. As illustrated in FIGS. 2 and 3, the electronic device ED may be folded with respect to a folding axis FX extending in the second direction DR2. Although FIGS. 2 and 3 illustrate that each of the folding area FA and the folding axis FX extends in a longer direction of the electronic device ED, embodiments are not limited thereto, and the folding area FA and the folding axis FX may each extend in a shorter direction of the electronic device ED.

In an embodiment, as illustrated in FIG. 2, the electronic device ED may be inwardly folded so that the display surface displaying the image IM does not face outside. For example, when the electronic device ED is folded, the first non-folded area NFA1 and the second non-folded area NFA2 of the display surface may face each other. In another embodiment, as illustrated in FIG. 3, the electronic device ED may be outwardly folded so that the display surface displaying the image IM faces outside.

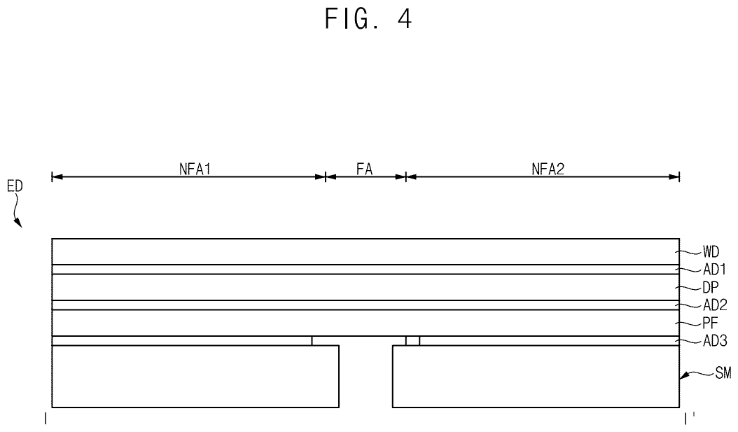

FIG. 4 is a schematic cross-sectional view of an electronic device according to an embodiment, taken along virtual line I-I′ in FIG. 1.

Referring to FIGS. 1 and 4, in an embodiment, the electronic device ED may include a display panel DP, a protective layer PF, a support SM, and a window WD. As described above, the electronic device ED may include the first non-folding area NFA1, the second non-folding area NFA2, and the folding area FA. The display panel DP, the protective layer PF, the support SM, and the window WD may each include the first non-folding area NFA1, the second non-folding area NFA2, and the folding area FA. The protective layer PF and the support SM may be arranged below (e.g., in a direction opposite to the third direction DR3) the display panel DP, and the window WD may be arranged above (e.g., in the third direction DR3) the display panel DP.

The display panel DP may include pixels for generating an image. The pixels may be arranged in the display area DA. The image may be generated by combining the light emitted by each of the pixels.

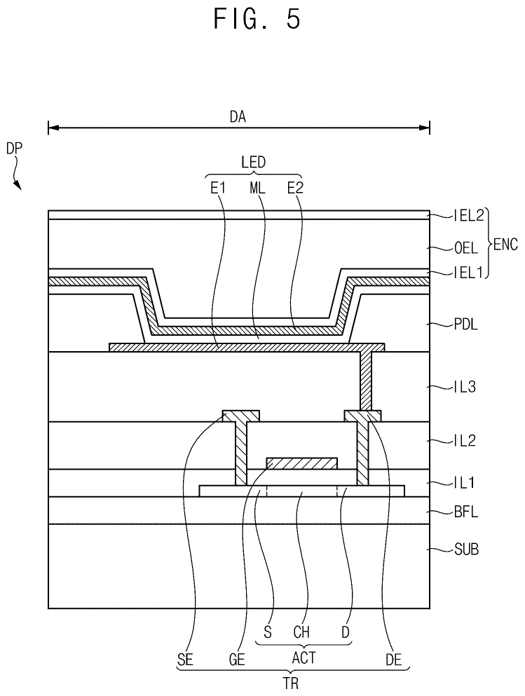

FIG. 5 is a schematic cross-sectional view of a display panel included in the electronic device of FIG. 4.

Hereinafter, a schematic cross-sectional structure of the display area DA of the display panel DP will be described in detail with reference to FIG. 5. Referring to FIG. 5, in an embodiment, the display panel DP may include a substrate SUB, a buffer layer BFL, the pixels, first to third insulating layers IL1, IL2, and IL3, a pixel defining layer PDL, and an encapsulation layer ENC. Each of the pixels may include a pixel circuit including at least one transistor TR and a light emitting element LED. The pixel circuit may further include at least one capacitor (not illustrated).

The substrate SUB may form a base of the display panel DP. The substrate SUB may be an insulating substrate that includes or is formed of a transparent or a non-transparent material. The substrate SUB may include plastic and may be flexible. The display panel DP may be a flexible display panel. The substrate SUB may have a single-layered structure, or the substrate SUB may have a multi-layered structure that includes multiple layers including different materials.

The buffer layer BFL may be arranged on the substrate SUB. The buffer layer BFL may prevent or reduce impurities, such as oxygen or moisture, from penetrating into an upper portion of the substrate SUB through substrate SUB. The buffer layer BFL may include an inorganic material. In an embodiment, for example, the buffer layer BFL may include silicon oxide (SiOₓ), silicon nitride (SiNₓ), silicon oxynitride (SiOₓN_{y}), silicon oxycarbide (SiOₓC_{y}), silicon carbonitride (SiCₓN_{y}), aluminum oxide (AlOₓ), aluminum nitride (AlNₓ), tantalum oxide (TaOₓ), hafnium oxide (HfOₓ), zirconium oxide (ZrOₓ), titanium oxide (TiOₓ), or the like. These inorganic materials may be used alone or in combination with each other. The buffer layer BFL may have a single-layered structure or a multi-layered structure that includes multiple insulating layers.

The transistor TR may be arranged on the buffer layer BFL. The transistor TR may include an active layer ACT, a gate electrode GE, a first contact electrode SE, and a second contact electrode DE.

The active layer ACT may be arranged on the buffer layer BFL. The active layer ACT may include an oxide semiconductor, a silicon semiconductor, an organic semiconductor, or the like. In an embodiment, for example, the oxide semiconductor may include at least one selected from oxides of indium (In), gallium (Ga), tin (Sn), zirconium (Zr), vanadium (V), hafnium (Hf), cadmium (Cd), germanium (Ge), chromium (Cr), titanium (Ti), and zinc (Zn). The silicon semiconductor may include amorphous silicon, polycrystalline silicon, or the like. The active layer ACT may include a first contact area S, a second contact area D, and a channel area CH located between the first contact area S and the second contact area D. Each of the first contact area S and the second contact area D may have higher conductivity than a conductivity of the channel area CH.

The first insulating layer IL1 may be arranged on the active layer ACT. The first insulating layer IL1 may cover the active layer ACT on the buffer layer BFL. The first insulating layer IL1 may include an inorganic insulating material.

The gate electrode GE may be arranged on the first insulating layer IL1. The gate electrode GE may overlap the channel area CH of the active layer ACT. The gate electrode GE may include a conductive material, such as a metal, an alloy, a conductive metal nitride, a conductive metal oxide, a transparent conductive material, or the like. For example, the gate electrode GE may include gold (Au), silver (Ag), aluminum (Al), platinum (Pt), nickel (Ni), titanium (Ti), palladium (Pd), magnesium (Mg), calcium (Ca), lithium (Li), chromium (Cr), tantalum (Ta), tungsten (W), copper (Cu), molybdenum (Mo), scandium (Sc), neodymium (Nd), iridium (Ir), alloys containing aluminum, alloys containing silver, alloys containing copper, alloys containing molybdenum, aluminum nitride (AlNₓ), tungsten nitride (WNₓ), titanium nitride (TiNₓ), chromium nitride (CrNₓ), tantalum nitride (TaNₓ), strontium ruthenium oxide (SrRuOₓ), zinc oxide (ZnOₓ), indium tin oxide (ITO), tin oxide (SnOₓ), indium oxide (InOₓ), gallium oxide (GaOₓ), indium zinc oxide (IZO), or the like. These conductive materials may be used alone or in combination with each other. The gate electrode GE may have a single-layered structure or a multi-layered structure that includes multiple conductive layers.

The second insulating layer IL2 may be arranged on the gate electrode GE. The second insulating layer IL2 may cover the gate electrode GE on the first insulating layer IL1. The second insulating layer IL2 may include an inorganic insulating material.

The first contact electrode SE and the second contact electrode DE may each be arranged on the second insulating layer IL2. The first contact electrode SE and the second contact electrode DE may be respectively connected to the first contact area S and the second contact area D of the active layer ACT. The first contact electrode SE and the second contact electrode DE may each include a conductive material.

The third insulating layer IL3 may be arranged on the first contact electrode SE and the second contact electrode DE. The third insulating layer IL3 may include an organic insulating material. In an embodiment, for example, the third insulating layer IL3 may include a photoresist, a polyacryl-based resin, a polyimide-based resin, a polyamide-based resin, a siloxane-based resin, an acryl-based resin, an epoxy-based resin, or the like. These may be used alone or in combination with each other.

The light emitting element LED may be arranged on the third insulating layer IL3. The light emitting element LED may include a first electrode E1, an intermediate layer ML, and a second electrode E2.

The first electrode E1 may be arranged on the third insulating layer IL3. The first electrode E1 may include a conductive material. The first electrode E1 may be connected to the second contact electrode DE through a contact hole formed in the third insulating layer IL3. Accordingly, the first electrode E1 may be electrically connected to the transistor TR. For example, the first electrode E1 may serve as an anode of the light emitting element LED.

The pixel defining layer PDL may be arranged on the first electrode E1. The pixel defining layer PDL may cover a peripheral portion of the first electrode E1, and may define a pixel opening that exposes a central portion of the first electrode E1. An emission area may be defined by the pixel opening. The pixel defining layer PDL may include an organic insulating material. In an embodiment, the pixel defining layer PDL may further include an inorganic material or an organic material containing a light blocking material having a black color.

The intermediate layer ML may be arranged on the first electrode E1 and the pixel defining layer PDL. A portion of the intermediate layer ML may be arranged in the pixel opening of the pixel defining layer PDL. In an embodiment, the intermediate layer ML may include a first functional layer including an organic material, an emission layer arranged on the first functional layer and including an emission material, and a second functional layer arranged on the emission layer and including an organic material. For example, the first functional layer may include a hole injection layer, a hole transport layer, or the like, and the second functional layer may include an electron transport layer, an electron injection layer, or the like.

In an embodiment, the emission layer may include at least one of an organic light emitting material and a quantum dot, but embodiments are not limited thereto.

In an embodiment, the organic light emitting material may include a low molecular weight organic compound or a high molecular weight organic compound. Examples of a low molecular weight organic compound may include copper phthalocyanine, N,N′-diphenylbenzidine, tris-(8-hydroxyquinoline)aluminum, or the like. Examples of a high molecular weight organic compound may include poly(3,4-ethylenedioxythiophene), polyaniline, poly-phenylenevinylene, polyfluorene, or the like. These can be used alone or in a combination thereof.

In an embodiment, the quantum dot may include a Group II-VI compound, a Group III-V compound, a Group IV-VI compound, a Group IV element, and/or a Group IV compound. In an embodiment, the quantum dot may have a core-shell structure that includes a core and a shell surrounding the core. The shell may serve as a protection layer that prevents the core from being chemically denatured to maintain semiconductor characteristics, and/or the shell may serve as a charging layer that imparts electrophoretic characteristics to the quantum dot.

The second electrode E2 may be arranged on the intermediate layer ML. The second electrode E2 may include a conductive material. For example, the second electrode E2 may serve as a cathode of the light emitting element LED.

The encapsulation layer ENC may be arranged on the second electrode E2. The encapsulation layer ENC may include at least one inorganic encapsulation layer and at least one organic encapsulation layer. In an embodiment, the encapsulation layer ENC may include a first inorganic encapsulation layer IEL1 arranged on the second electrode E2, an organic encapsulation layer OEL arranged on the first inorganic encapsulation layer IEL1, and a second inorganic encapsulation layer IEL2 arranged on the organic encapsulation layer OEL. Although not shown in the drawings, in an embodiment, various functional layers, such as a touch sensing layer, a color filter layer, a light collecting layer, or the like may be further included on the encapsulation layer ENC.

Referring again to FIGS. 1 and 4, the protective layer PF may be arranged below the display panel DP. The protective layer PF may protect a lower surface of the display panel DP. In an embodiment, the protective layer PF may include plastic and may be flexible. For example, the protective layer PF may include (or may be) a polyethyleneterephthalate (PET) film or a polyimide (PI) film, but embodiments are not limited thereto.

The support SM may be arranged below the protective layer PF. The support SM may support the display panel DP and may prevent deformation of the display panel DP from external impact, or the like. In an embodiment, the support SM may include various functional layers, such as a cushion layer, a shielding layer, a heat dissipation layer, a support plate, or the like.

The window WD may be arranged above the display panel DP. The window WD may cover the entire upper surface (e.g., the display surface) of the display panel DP. The window WD may protect the display panel DP from external impact. The window WD may be flexible so as to be folded according to the folding of the electronic device ED. The window WD will be described in detail later.

In an embodiment, as illustrated in FIG. 4, adhesive layers AD1, AD2, and AD3 may be arranged between respective components of the electronic device ED. For example, a first adhesive layer AD1 may be arranged between the display panel DP and the window WD, a second adhesive layer AD2 may be arranged between the display panel DP and the protective layer PF, and a third adhesive layer AD3 may be arranged between the protective layer PF and the support SM. Each of the adhesive layers AD1, AD2, and AD3 may include (or may be) a pressure sensitive adhesive film (“PSA”), an optically clear adhesive film (“OCA”), an optically clear resin (“OCR”), or the like.

Although not shown in the drawings, the electronic device ED may further include a housing that is coupled with the window WD. The housing may be coupled with the window WD to provide an internal space. The display panel DP, the protective layer PF, and the support SM may be accommodated in the internal space provided between the housing and the window WD. The housing may stably protect the components that are accommodated in the internal space from external impact.

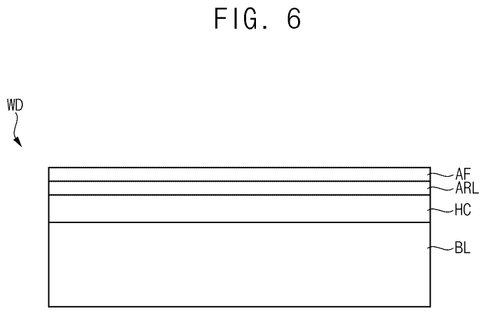

FIG. 6 is a schematic cross-sectional view of a window included in the electronic device of FIG. 4.

Referring to FIG. 6, in an embodiment, the window WD may include a base layer BL and a hard coating layer HC.

In an embodiment, the base layer BL may include a plastic film and may be flexible. For example, the base layer BL may include a PET film or a PI film, but embodiments are not limited thereto.

The hard coating layer HC may be arranged on the base layer BL. In an embodiment, the hard coating layer HC may be arranged directly on an upper surface of the base layer BL. The hard coating layer HC may have a relatively greater hardness. For example, the hardness of the hard coating layer HC may be greater than a hardness of the base layer BL. The hard coating layer HC may increase durability of the window WD so as to effectively protect the display panel DP from external impact. The hard coating layer HC may be flexible so as to be foldable.

The hard coating layer HC may include a polymer compound, a photo-polymerization initiator, and silica nanoparticles. In an embodiment, a thickness of the hard coating layer HC may be in a range of about 3 micrometers (μm) to about 5 μm. The hard coating layer HC will be described in further detail below, along with a method for manufacturing the window WD.

In an embodiment, the window WD may further include an anti-reflection layer ARL and an anti-fingerprint layer AF arranged on the hard coating layer HC.

The anti-reflection layer ARL may reduce external light reflectance of the window WD. In an embodiment, the anti-reflection layer ARL may include high refractive index layers and low refractive index layers. A refractive index of each of the high refractive index layers may be greater than a refractive index of each of the low refractive index layers. The high refractive index layers and the low refractive index layers may be alternately stacked on each other in the thickness direction (e.g., the third direction DR3 of FIG. 1).

In an embodiment, the low refractive index layers may each include silicon aluminum oxide (SiₓAl_{y}O_{z}). For example, the low refractive index layers may each include Si₉Al₂O₁₀, but embodiments are not limited thereto.

In an embodiment, the high refractive index layers may each include titanium niobium oxide (TiₓNb_{y}O_{z}). For example, the high refractive index layers may each include Ti₁₄Nb₃O₃₅, but embodiments are not limited thereto.

The anti-fingerprint layer AF may be arranged on the anti-reflection layer ARL. The anti-fingerprint layer AF may prevent fingerprints from being formed on an upper surface of the electronic device ED. For example, the anti-fingerprint layer AF may include a metal oxide, a silicon-based compound, a fluorine-based compound, or the like. In an embodiment, at least one of the anti-reflection layer ARL and the anti-fingerprint layer AF may be omitted.

Hereinafter, a method for manufacturing the window WD according to an embodiment will be described in detail.

According to embodiments, a hard coating composition may be prepared. The hard coating composition may include a solvent, a polymer compound, a photo-polymerization initiator, and silica nanoparticles. Hereinafter, the phrase “hard coating solid matter” may refer to all components other than the solvent in the hard coating composition. For example, the term “hard coating solid matter” may encompass the polymer compound, the photo-polymerization initiator, and the silica nanoparticles.

In an embodiment, the solvent may include a ketone-based solvent and/or an alcohol-based solvent. For example, the solvent may include at least one of 2-butanone (“MEK”) and 1-methoxy-2-methyl-2-propanol (“PGM”). For example, a mixture of MEK and PGM may be used as the solvent, or as another example, MEK or PGM may be used alone as the solvent. An amount of the solvent in the hard coating composition may be in a range of about 70 wt % to about 90 wt %, with respect to 100 wt % of the hard coating composition. However, this is only an example and embodiments are not limited thereto.

The polymer compound may be a photo-polymerizable compound having a photo-polymerizable functional group. According to embodiments, the polymer compound may be a silsesquioxane compound represented Formula 1:

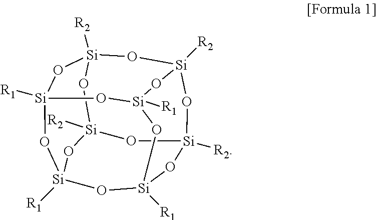

In Formula 1, R₁ and R² represent different photo-polymerizable functional groups, and may each independently be a substituted or unsubstituted (meth)acrylate group.

The silsesquioxane compound may have two types of functional groups, represented by R₁ and R₂. When the silsesquioxane compound has a mono-functional group, the hardness and wear resistance of the hard coating layer HC may decrease. When the silsesquioxane compound has three or more types of functional groups, it may be difficult to control shrinkage of the silsesquioxane compound during a curing process of the hard coating composition, so that the thickness of the hard coating layer HC may become uneven.

In an embodiment, R₁ may represent pentaerythritol tetraacrylate (“PETA”), and R₂ may represent trimethylolpropane trimethacrylate (“TMPTMA”). In an embodiment, a ratio of PETA functional groups to TMPTMA functional groups in the silsesquioxane compound may be in a range of about 4:6 to about 6:4. For example, the ratio of PETA functional groups to TMPTMA functional groups in the silsesquioxane compound may be in a range of about 4.5:5.5 to about 5.5:4.5.

In an embodiment, as shown in Formula 1, the silsesquioxane compound may have a T8 cage structure. However, embodiments are not limited thereto, and the silsesquioxane compound may have various structures, such as a T10 heptahedral structure, a T12 octahedral structure, a ladder structure, or the like. Even when the silsesquioxane compound has a structure other than the T8 cage structure, the ratio of PETA functional groups to TMPTMA functional groups in the silsesquioxane compound may be in a range of about 4:6 to about 6:4. For example, the ratio of PETA functional groups to TMPTMA functional groups in the silsesquioxane compound may be in a range of about 4.5:5.5 to about 5.5:4.5.

The photo-polymerization initiator may initiate a polymerization reaction of the photo-polymerizable compound. The photo-polymerization initiator may generate radicals upon exposure to light, and thus the hard coating composition may be photo-cured. In an embodiment, the photo-polymerization initiator may be diphenyl(2,4,6-trimethylbenzoyl) phosphine oxide, but embodiments are not limited thereto.

The silica nanoparticles may be dispersed in the hard coating composition. The silica nanoparticles may partially bind to the silsesquioxane compound to enhance bonding strength and may improve wear resistance of the hard coating layer HC. In an embodiment, an average diameter of the silica nanoparticles may be in a range of about 20 nanometers (nm) to about 60 nm.

In an embodiment, the hard coating solid matter of the hard coating composition may include, with respect to 100 wt % of the hard coating solid matter, about 85 wt % to about 95 wt % of the silsesquioxane compound, about 1 wt % to about 5 wt % of the photo-polymerization initiator, and about 2 wt % to about 10 wt % of the silica nanoparticles. For example, the hard coating solid matter, with respect to 100 wt % of the hard coating solid matter, may include about 90 wt % to about 95 wt % of the silsesquioxane compound, about 1 wt % to about 3 wt % of the photo-polymerization initiator, and about 2 wt % to about 5 wt % of the silica nanoparticles. In an embodiment, the hard coating composition may further include an additive for controlling flexibility and/or hardness of the hard coating layer HC.

The prepared hard coating composition may be applied on the base layer BL to form a preliminary hard coating layer. The hard coating composition may be applied on one surface of the base layer BL. In an embodiment, the hard coating composition may be applied by wet coating, but embodiments are not limited thereto.

The preliminary hard coating layer formed on the base layer BL can be dried. In the step of drying the preliminary hard coating layer, the solvent included in the hard coating composition may be removed.

The dried preliminary hard coating layer may be photo-cured to form the hard coating layer HC. The preliminary hard coating layer may include the hard coating solid matter including the silsesquioxane compound, the photo-polymerization initiator, and the silica nanoparticles. When light is irradiated, a photo-polymerization reaction of the silsesquioxane compound including the photo-polymerizable functional group may be initiated by the photo-polymerization initiator. The hard coating layer HC may include a cross-linked structure formed by curing the silsesquioxane compound. In an embodiment, the thickness of the hard coating layer HC may be in a range of about 3 micrometers to about 5 micrometers.

The anti-reflection layer ARL may be formed on the hard coating layer HC. In an embodiment, the high refractive index layers and the low refractive index layers may be alternately stacked on the hard coating layer HC. In an embodiment, the high refractive index layers and the low refractive index layers may each be formed by vacuum deposition. The anti-fingerprint layer AF may be coated on the anti-reflection layer ARL to form the window WD.

According to embodiments, the hard coating layer HC of the window WD may have excellent flexibility while also improving hardness and wear resistance. Accordingly, the flexibility and the durability of the window WD may be improved, so that the window WD may be suitable for use in a foldable electronic device. Hereinafter, embodiments will be described through experimental examples.

### [Evaluation of Window]

A window according to a comparative example and a window according to an embodiment were each manufactured, and crack strain, surface hardness, wear resistance, and chemical resistance of each of the windows were evaluated.

### [Manufacture of Window]

The window according to the comparative example and the window according to the embodiment were each manufactured by forming a hard coating layer having a thickness of 5 micrometers on a PET film having a thickness of 65 micrometers, and alternately vacuum depositing a total of five layers of Ti₁₄Nb₃O₃₅ films and Si₉Al₂O₁₀ films on the hard coating layer. The window according to the comparative example and the window according to the embodiment were manufactured under the same conditions, except for the hard coating composition used in the manufacture of the hard coating layer.

The hard coating layer of the comparative example was formed of a hard coating composition including 95 wt % of a silsesquioxane compound having a T8 cage structure and having a 2-ethylhexyloxetane mono-functional group as the photo-polymerizable compound, 3 wt % of 2-(1,3-Benzodioxol-5-yl)-4,6-bis(trichloromethyl)-1,3,5-triazine as the photo-polymerization initiator, and 2 wt % of the additive with respect to 100 wt % of the hard coating solid matter.

The hard coating layer of the embodiment was formed of a hard coating composition including 93 wt % of the silsesquioxane compound having a T8 cage structure and having a PETA functional group and a TMPTMA functional group as the photo-polymerizable compound, 2 wt % of diphenyl(2,4,6-trimethylbenzoyl) phosphine oxide as the photo-polymerization initiator, 3 wt % of silica nanoparticles, and 2 wt % of the additive, with respect to 100 wt % of the hard coating solid matter.

The evaluation methods for crack strain, surface hardness, wear resistance, and chemical resistance are as follows.

### (1) Crack Strain

Crack strain indicates a level of increase in the size of a sample after extending an initial test sample. The test samples for measuring crack strain measurement were prepared by cutting the windows according to the comparative example and the embodiment into a size of 10 mm×60 mm. Each of the prepared test samples was tensioned using a universal testing machine (Instron Corporation) with the tensile speed of 50 mm/min. After tensioning, the occurrence of cracks was checked and the level of increase in the size of the samples was measured for evaluation.

### (2) Surface Hardness

Surface hardness was measured using a nano-indenter (TI-950 Berkovich diamond Tip, Bruker Corporation), and a surface of the test sample was indented with an indentation depth of 200 nanometers.

### (3) Wear Resistance

Wear resistance was evaluated by measuring the water contact angle after abrasion tests with an eraser. The test samples for measuring wear resistance measurement were prepared by cutting the windows according to the comparative example and the embodiment into a size of 70 mm×80 mm. Each of the prepared test samples was fixed to a jig of a wear resistance measuring device (scratch tester, Daesung Precision Corporation), and an eraser (Rubber stick, Munbang Sau Corporation) having a diameter of 5 mm was applied and fixed on the tip. A moving distance of 15 mm, a moving rate of 50 rpm, and a load of 1.0 kg were set, the eraser was reciprocally rubbed on a surface of each of the test samples to visually observe the surface or the water contact angle of a worn surface was measured using a drop shape analysis system (Kruss Corporation).

### (4) Chemical Resistance

Chemical resistance was evaluated by applying alcohol to a surface of each of the test samples, reciprocally rubbing an eraser on the surface of each of the test samples under the same conditions as those for evaluating the wear resistance, and visually observing the surface or measuring the water contact angle of the worn surface.

Table 1 shows the results of evaluating crack strain, hardness, wear resistance, and chemical resistance for the windows according to comparative example and the embodiment.

TABLE 1

| | | Comparative | |
|---|---|---|---|
| | | Example | Embodiment |
| crack strain | | 16.0 | 7.5 |
| surface hardness (GPa) | | 0.52 | 0.7 |
| wear | number of times rubbed | 3000 | 10000 |
| resistance | water contact angle (°) | <95 | 106.1 |
| chemical | number of times rubbed | 2000 | 3000 |
| resistance | water contact angle (°) | <95 | 101.7 |

Referring to Table 1, it can be noted that the window of the comparative example, due to the silsesquioxane compound having a mono-functional group, has excellent flexibility, resulting in a very high crack strain, but has low surface hardness, low wear resistance, and low chemical resistance. The window of the embodiment was measured to have a crack strain of 7.5%, exceeding the target value of 7%, and exhibited greater surface hardness, greater wear resistance, and greater chemical resistance, as compared to the window of the comparative example. With respect to the wear resistance and chemical resistance tests, the surface of the comparative example was observed to be damaged after 3,000 and 2,000 reciprocal rubbing cycles, respectively, while the window of the embodiment maintained good surface characteristics even after 10,000 and 3,000 reciprocal rubbing cycles. After the wear resistance and chemical resistance tests, the water contact angle of the window of the embodiment remained above the target value of 95°, indicating that the window of the embodiment has excellent wear and chemical resistance.

Embodiments have been disclosed herein, and although terms are employed, they are used and are to be interpreted in a generic and descriptive sense only and not for the purposes of limitation. In some instances, as would be apparent to one of ordinary skill in the art, features, characteristics, and/or elements described in connection with an embodiment may be used singly or in combination with features, characteristics, and/or elements described in connection with other embodiments unless otherwise specifically indicated. Accordingly, it will be understood by those of ordinary skill in the art that various changes in form and details may be made without departing from the spirit and scope of the disclosure as set forth in the claims.

What is claimed is:

1. A hard coating composition comprising:
a solvent; and
a hard coating solid matter, wherein
the hard coating solid matter includes:
a silsesquioxane compound represented by Formula 1; and
a photo-polymerization initiator: 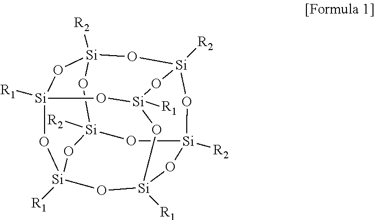
wherein in Formula 1,
R₁ represents pentaerythritol tetraacrylate, and
R₂ represents trimethylolpropane trimethacrylate.

2. The hard coating composition of claim 1, wherein the hard coating solid matter further includes silica nanoparticles.

3. The hard coating composition of claim 2, wherein with respect to 100 wt % of the hard coating solid matter, the hard coating solid matter includes:
about 85 wt % to about 95 wt % of the silsesquioxane compound;
about 1 wt % to about 5 wt % of the photo-polymerization initiator; and
about 2 wt % to about 10 wt % of the silica nanoparticles.

4. The hard coating composition of claim 2, wherein an average diameter of the silica nanoparticles is in a range of about 20 nanometers (nm) to about 60 nm.

5. The hard coating composition of claim 1, wherein the photo-polymerization initiator is diphenyl(2,4,6-trimethylbenzoyl) phosphine oxide.

6. The hard coating composition of claim 1, wherein the solvent includes at least one of 2-butanone and 1-methoxy-2-methyl-2-propanol.

7. A window comprising:
a base layer; and
a hard coating layer on the base layer, wherein
the hard coating layer includes:
a silsesquioxane compound represented by Formula 1; and
a photo-polymerization initiator: 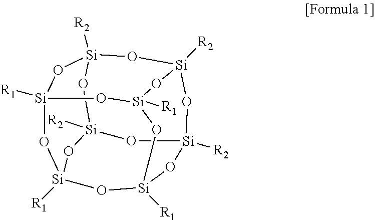
wherein in Formula 1,
R₁ represents pentaerythritol tetraacrylate, and
R₂ represents trimethylolpropane trimethacrylate.

8. The window of claim 7, wherein the hard coating layer further includes silica nanoparticles.

9. The window of claim 8, wherein an average diameter of the silica nanoparticles is in a range of about 20 nm to about 60 nm.

10. The window of claim 7, wherein the photo-polymerization initiator is diphenyl(2,4,6-trimethylbenzoyl)phosphine oxide.

11. The window of claim 7, wherein a thickness of the hard coating layer is in a range of about 3 micrometers (μm) to about 5 μm.

12. The window of claim 7, further comprising:
an anti-reflection layer on the hard coating layer, wherein
the anti-reflection layer includes a plurality of high refractive index layers and a plurality of low refractive index layers, alternately stacked on each other.

13. An electronic device comprising:
a display panel including a plurality of pixels; and
a window on the display panel, wherein
the window includes:
a base layer; and
a hard coating layer on the base layer, and
the hard coating layer includes:
a silsesquioxane compound represented by Formula 1; and
a photo-polymerization initiator: 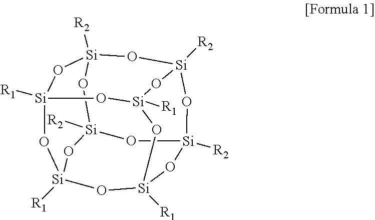
wherein in Formula 1,
R₁ represents pentaerythritol tetraacrylate, and
R₂ represents trimethylolpropane trimethacrylate.
